(19) United States
(12) Patent Application Publication
(10) Pub. No.: US 2020/0355964 A1
(43) Pub. Date: Nov. 12, 2020

(54) IMAGE DISPLAY DEVICE

(71) Applicant: NITTO DENKO CORPORATION, Ibaraki-shi, Osaka (JP)

(72) Inventors: Hideyuki Yonezawa, Ibaraki-shi (JP); Hiroyuki Takemoto, Ibaraki-shi (JP)

(73) Assignee: NITTO DENKO CORPORATION, Ibaraki-shi, Osaka (JP)

(21) Appl. No.: 16/766,082

(22) PCT Filed: Sep. 28, 2018
(86) PCT No.: PCT/JP2018/036260

§ 371 Date: May 21, 2020

(30) Foreign Application Priority Data
Nov. 22, 2017 (JP) 2017-225080

(51) Int. Cl. G02F 1/13357; G02F 1/1335

(52) U.S. Cl. CPC G02F 1/133606; G02F 1/133528; G02F 1/13363; G02F 2001/133541; G02F 1/133603

(57) ABSTRACT

The image display apparatus includes in the stated order from a viewer side thereof: a light-diffusing element; a circularly polarizing plate; and a backlight, wherein the light-diffusing element has a half-value angle of from 40° to 80°, wherein the light-diffusing element has a diffuse reflectance of less than 1.5%, and wherein the backlight has a half-value angle of 30° or less. The circularly polarizing plate includes a polarizer and a first retardation layer in the stated order from the viewer side, the first retardation layer shows a refractive index characteristic of nx>ny≥nz, the first retardation layer has an in-plane retardation Re(550) of from 120 nm to 160 nm, and an angle formed by an absorption axis of the polarizer and a slow axis of the first retardation layer is from 35° to 55°, where Re(550) represents an in-plane retardation measured at 23° C. with light having a wavelength of 550 nm.

### TECHNICAL FIELD

The present invention relates to an image display apparatus.

### BACKGROUND ART

The number of opportunities for use of a display apparatus for, for example, a smart device typified by a smart phone, digital signage, or a window display under strong ambient light has been increasing in recent years. Along with the increase, there has been occurring a problem such as: the reflection of the ambient light by the display apparatus itself or a reflector to be used in the display apparatus, such as a touch panel portion, a glass substrate, or a metal wiring; or the reflection of a background on the display apparatus or the reflector. In view of the foregoing, it has been known that such problem is prevented by arranging a circularly polarizing plate including a λ/4 plate on the viewer side of the apparatus.

Meanwhile, in a liquid crystal display apparatus, an improvement in viewing angle characteristic has heretofore been strongly desired because a contrast reduction or a hue change occurs when the apparatus is viewed from an oblique direction. A compensation film has been frequently used for improving the viewing angle characteristic. However, an image display apparatus (liquid crystal display apparatus) including a circularly polarizing plate as described above involves a problem in that the design of the compensation film is difficult, and hence a sufficient viewing angle characteristic is hardly obtained.

### CITATION LIST

### Patent Literature

[PTL 1] JP 2010-015038 A

### SUMMARY OF INVENTION

### Technical Problem

The present invention has been made to solve the conventional problems, and an object of the present invention is to provide an image display apparatus, which is capable of preventing ambient light reflection, and is excellent in viewing angle characteristic.

### Solution to Problem

According to one embodiment of the present invention, there is provided an image display apparatus, including in the stated order from a viewer side thereof: a light-diffusing element; a circularly polarizing plate; and a backlight, wherein the light-diffusing element has a half-value angle of from 40° to 80° wherein the light-diffusing element has a diffuse reflectance of less than 1.5%, and wherein the backlight has a half-value angle of 30° or less.

In one embodiment, the circularly polarizing plate includes a polarizer and a first retardation layer in the stated order from the viewer side, the first retardation layer shows a refractive index characteristic of nx>ny≥nz, the first retardation layer has an in-plane retardation Re(550) of from 120 nm to 160 nm, and an angle formed by an absorption axis of the polarizer and a slow axis of the first retardation layer is from 35° to 55°, where Re(550) represents an in-plane retardation measured at 23° C. with light having a wavelength of 550 nm.

In one embodiment, the first retardation layer satisfies a relationship of 0.8≤Re(450)/Re(550)≤1.05 where Re(450) represents an in-plane retardation measured at 23° C. with light having a wavelength of 450 nm, and Re(550) represents the in-plane retardation measured at 23° C. with the light having a wavelength of 550 nm.

In one embodiment, the circularly polarizing plate includes a polarizer, a second retardation layer, and a third retardation layer in the stated order from the viewer side, the second retardation layer shows a refractive index characteristic of nx>ny≥nz, the third retardation layer shows a refractive index characteristic of nz>nx≥ny, a laminated retardation film including the second retardation layer and the third retardation layer has an in-plane retardation Re(550) of from 120 nm to 160 nm, and a thickness direction retardation Rth(550) of from 40 nm to 100 nm, and an angle formed by an absorption axis of the polarizer and a slow axis of the second retardation layer is from 35° to 55°, where Re(550) represents an in-plane retardation measured at 23° C. with light having a wavelength of 550 nm, and Rth(550) represents a thickness direction retardation measured at 23° C. with the light having a wavelength of 550 nm.

In one embodiment, the second retardation layer satisfies a relationship of 0.8≤Re(450)/Re(550)≤1.05 where Re(450) represents an in-plane retardation measured at 23° C. with light having a wavelength of 450 nm, and Re(550) represents the in-plane retardation measured at 23° C. with the light having a wavelength of 550 nm.

In one embodiment, the image display apparatus further includes a liquid crystal cell of a VA mode between the circularly polarizing plate and the backlight.

In one embodiment, the backlight includes a LED light source.

### Advantageous Effects of Invention

According to the present invention, the image display apparatus, which is capable of preventing ambient light reflection, and is excellent in viewing angle characteristic can be provided.

### BRIEF DESCRIPTION OF DRAWINGS

FIG. 1 is a schematic sectional view of an image display apparatus according to one embodiment of the present invention.

FIG. 2 is a schematic sectional view of a light-diffusing film according to one embodiment of the present invention.

FIG. 3 is a schematic sectional view of a circularly polarizing plate according to one embodiment of the present invention.

FIG. 4 is a schematic sectional view of a circularly polarizing plate according to another embodiment of the present invention.

FIG. 5 is a schematic view for illustrating a method of calculating the half-value angle of a light-diffusing element.

FIG. 6 is a schematic view for illustrating a method of calculating the half-value angle of a backlight.

### DESCRIPTION OF EMBODIMENTS

### Definitions of Terms and Symbols

The definitions of terms and symbols used herein are as described below.

### (1) Refractive Indices (nx, ny, and nz)

“nx” represents a refractive index in a direction in which an in-plane refractive index is maximum (that is, slow axis direction), “ny” represents a refractive index in a direction perpendicular to the slow axis in the plane (that is, fast axis direction), and “nz” represents a refractive index in a thickness direction.

### (2) In-Plane Retardation (Re)

“Re(550)” refers to an in-plane retardation measured at 23° C. with light having a wavelength of 550 nm. The Re(550) is determined from the equation “Re=(nx−ny)×d” when the thickness of a layer (film) is represented by “d” (nm). “Re(450)” refers to an in-plane retardation measured at 23° C. with light having a wavelength of 450 nm.

### (3) Thickness Direction Retardation (Rth)

“Rth(550)” refers to a thickness direction retardation measured at 23° C. with light having a wavelength of 550 nm. The Rth(550) is determined from the equation “Rth=(nx−nz)×d” when the thickness of a layer (film) is represented by “d” (nm). “Rth(450)” refers to a thickness direction retardation measured at 23° C. with light having a wavelength of 450 nm.

### (4) Nz Coefficient

An Nz coefficient is determined from the equation “Nz=Rth/Re”.

A. Overall Configuration of Image Display Apparatus

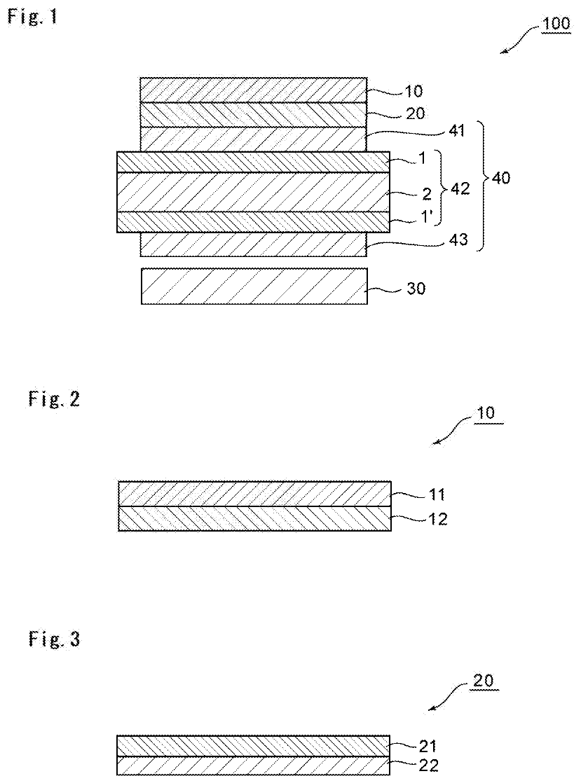

FIG. 1 is a schematic sectional view of an image display apparatus according to one embodiment of the present invention. An image display apparatus 100 includes a light-diffusing element 10, a circularly polarizing plate 20, and a backlight 30 in the stated order from its viewer side. In FIG. 1, a case in which the image display apparatus is a liquid crystal display apparatus is illustrated as a typical example. When the image display apparatus is a liquid crystal display apparatus, the liquid crystal display apparatus 100 may include a liquid crystal panel 40 between the circularly polarizing plate 20 and the backlight 30. The image display apparatus may further include any appropriate other member. The respective members to be included in the image display apparatus may be laminated via any appropriate pressure-sensitive adhesive or adhesive.

In the present invention, the image display apparatus includes the circularly polarizing plate, and hence can be prevented from ambient light reflection. In addition, when the light-diffusing element is arranged on the viewer side of the circularly polarizing plate, an image display apparatus having the following features can be obtained: the apparatus is excellent in viewing angle characteristic; and a contrast reduction and a hue change when the apparatus is viewed from an oblique direction are reduced. In addition, when the image display apparatus includes the circularly polarizing plate and the light-diffusing element, an image display apparatus reduced in white blurring can be obtained. Those effects become particularly significant when the half-value angle of the light-diffusing element is set to from 40° to 80°, the diffuse reflectance of the light-diffusing element is set to less than 1.5%, and the half-value angle of the backlight is set to 30° or less.

B. Light-Diffusing Element

The light-diffusing element includes a light-diffusing layer. In one embodiment, the light-diffusing element further includes a substrate. FIG. 2 is a schematic sectional view of a light-diffusing film according to one embodiment of the present invention. The light-diffusing element 10 includes a light-diffusing layer 11 and a substrate 12 arranged on one side of the light-diffusing layer 11. The light-diffusing element may be arranged so that the light-diffusing layer may be on the viewer side, or may be arranged so that the substrate may be on the viewer side.

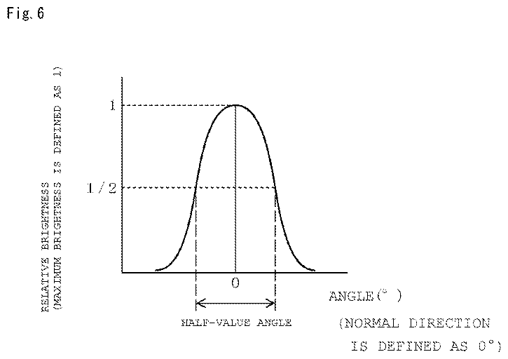

The half-value angle of the light-diffusing element is from 40° to 80°, preferably from 45° to 75°, more preferably from 50° to 70°. The use of the light-diffusing element showing such half-value angle can provide an image display apparatus having the following features: the apparatus is excellent in viewing angle characteristic; and a contrast reduction and a hue change when the apparatus is viewed from an oblique direction are reduced. In the present invention, as illustrated in FIG. 5 or FIG. 6, the half-value angle refers to the full width at half maximum of the angles at which a brightness becomes ½ when an angle is changed from the direction in which the brightness becomes maximum. The half-value angle of the light-diffusing element is a value (angle A+angle A′ in FIG. 5) obtained by: irradiating the front surface of the light-diffusing element with laser light; measuring the diffusion brightness of diffused light with respect to a diffusion angle with a goniophotometer every 1°; measuring the diffusion angles at which the brightness becomes one half of the maximum value of the diffusion brightness of light except the straight transmitted light of the laser on both sides of a diffusion profile as illustrated in FIG. 5; and summing up the angles on both the sides.

The haze of the light-diffusing element is preferably from 10% to 80%, more preferably from 20% to 70%, still more preferably from 30% to 60%. When the haze falls within such ranges, a light-diffusing element suitable for an image display apparatus, such as a liquid crystal display apparatus, can be obtained.

The diffuse reflectance of the light-diffusing element is preferably less than 1.5%, more preferably 1% or less, still more preferably from 0.3% to 0.8%. The use of the light-diffusing element showing such diffuse reflectance can provide an image display apparatus having the following features: the apparatus is excellent in viewing angle characteristic; and a contrast reduction and a hue change when the apparatus is viewed from an oblique direction are reduced. A method of measuring the diffuse reflectance of the light-diffusing element is described later.

The total light transmittance of the light-diffusing element is preferably 80% or more, more preferably 85% or more, still more preferably 90% or more. When the image display apparatus includes the light-diffusing element having such total light transmittance, an image display apparatus excellent in contrast can be obtained. When the total light transmittance of the light-diffusing element is less than 80%, the white brightness of the image display apparatus may be reduced. Although the total light transmittance of the light-diffusing element is preferably as high as possible, its upper limit is, for example, 98%.

The thickness of the light-diffusing layer may be appropriately set in accordance with a purpose and a desired diffusion characteristic. Specifically, the thickness of the light-diffusing layer is preferably from 1 μm to 50 μm, more preferably from 2 μm to 20 μm, still more preferably from 2 μm to 10 μm. The use of a light-diffusing film including the light-diffusing layer having such thickness can provide a liquid crystal display apparatus, which is excellent in contrast and viewing angle characteristic.

In one embodiment, the light-diffusing layer contains a binder resin and light-diffusible particles. The light-diffusible particles are dispersed in the binder resin.

Any appropriate resin may be used as the binder resin as long as the effect of the present invention is obtained. An ionizing radiation-curable resin is preferably used as the binder resin. Examples of the ionizing radiation include UV light, visible light, an infrared ray, and an electron beam. Of those, UV light is preferred. Therefore, a resin component particularly preferably includes a UV-curable resin. An example of the UV-curable resin is a resin formed from a radical polymerization-type monomer and/or oligomer, such as an acrylate resin (epoxy acrylate, polyester acrylate, acrylic acrylate, or ether acrylate). The molecular weight of the monomer component (precursor) for forming the acrylate resin is preferably from 200 to 700. Specific examples of the monomer component (precursor) for forming the acrylate resin include pentaerythritol triacrylate (PETA: molecular weight: 298), neopentyl glycol diacrylate (NPGDA: molecular weight: 212), dipentaerythritol hexaacrylate (DPHA: molecular weight: 632), dipentaerythritol pentaacrylate (DPPA: molecular weight: 578), and trimethylolpropane triacrylate (TMPTA: molecular weight: 296). An initiator may be added to the precursor as required. Examples of the initiator include UV radical generators (e.g., IRGACURE 907, IRGACURE 127, and IRGACURE 192 manufactured by BASF Japan Ltd.) and benzoyl peroxide. The resin component may contain another resin component except the ionizing radiation-curable resin. The other resin component may be an ionizing radiation-curable resin, may be a thermosetting resin, or may be a thermoplastic resin. Typical examples of the other resin component include an aliphatic (e.g., polyolefin) resin and a urethane-based resin.

The refractive index of the binder resin is preferably from 1.2 to 2.4, more preferably from 1.4 to 2.0. The use of the binder resin having such refractive index can provide a light-diffusing film excellent in light diffusibility.

In one embodiment, the refractive index of the binder resin is preferably from 1.4 to 1.6, more preferably from 1.4 to 1.55. The binder resin having such refractive index may be used in combination with, for example, light-diffusible particles each having a void. The refractive index of each of the light-diffusible particles each having a void is, for example, from 1 to 1.4 (preferably from 1 to 1.2).

In addition, in another embodiment, the refractive index of the binder resin is preferably from 1.6 to 2.4, more preferably from 1.6 to 2.0. The binder resin having such refractive index may be used in combination with, for example, solid light-diffusible particles. The refractive index of each of the solid light-diffusible particles is, for example, from 1.2 to 2 (preferably from 1.4 to 1.6).

The absolute value of a difference between the refractive index of the binder resin and the refractive index of each of the light-diffusible particles is preferably from 0.02 to 0.7, more preferably from 0.05 to 0.5. When the difference falls within such ranges, a light-diffusing film excellent in light diffusibility can be obtained.

Organic particles may be used as the light-diffusible particles, or inorganic particles may be used. Of those, the organic particles are preferably used. As a material for forming each of the light-diffusible particles, there are given, for example, polymethyl methacrylate, polymethyl acrylate, an acrylic-styrene copolymer, melamine, polycarbonate, polystyrene, polyvinyl chloride, benzoguanamine-melamine formaldehyde, and silica. Of those, polymethyl methacrylate is preferred.

The light-diffusible particles may be solid particles, or may be particles each having a void therein.

The refractive index of each of the light-diffusible particles is preferably from 1 to 2, more preferably from 1.4 to 1.6. When the refractive index falls within such ranges, a light-diffusing film excellent in light diffusibility can be obtained.

The number-average particle diameter of the light-diffusible particles is preferably from 0.1 μm to 3 μm, more preferably from 0.3 μm to 2 μm, still more preferably from 0.3 μm to 1.5 μm, still further more preferably from 0.5 μm to 1.5 μm. The use of a light-diffusing film including the light-diffusing layer including such light-diffusible particles can provide a liquid crystal display apparatus, which is excellent in contrast and viewing angle characteristic. In this description, the average particle diameter of the light-diffusible particles in the light-diffusing layer is measured by observing a section of the light-diffusing layer with a microscope.

When the light-diffusible particles are particles each having a void, the average void size diameter of the particles is preferably from 0.1 μm to 3 μm, more preferably from 0.3 μm to 2 μm, still more preferably from 0.3 μm to 1.5 μm, still further more preferably from 0.5 μm to 1.5 μm. The use of a light-diffusing film including the light-diffusing layer including such light-diffusible particles can provide an image display apparatus, which is excellent in contrast and viewing angle characteristic. In this description, the average void size diameter is measured by observing a section of the light-diffusing layer with a microscope.

The content of the light-diffusible particles is preferably from 1 part by weight to 60 parts by weight, more preferably from 2 parts by weight to 50 parts by weight, still more preferably from 5 parts by weight to 40 parts by weight with respect to 100 parts by weight of the binder resin.

In one embodiment, the light-diffusing layer further contains an ultrafine particle component. In this embodiment, organic particles are preferably used as the light-diffusible particles. The ultrafine particle component preferably includes an inorganic compound. The inorganic compound is preferably, for example, a metal oxide or a metal fluoride. Specific examples of the metal oxide include zirconium oxide (zirconia) (refractive index: 2.19), aluminum oxide (refractive index: 1.56 to 2.62), titanium oxide (refractive index: 2.49 to 2.74), and silicon oxide (refractive index: 1.25 to 1.46). Specific examples of the metal fluoride include magnesium fluoride (refractive index: 1.37) and calcium fluoride (refractive index: 1.40 to 1.43). The refractive index of the ultrafine particle component is preferably 1.40 or less or 1.60 or more, more preferably 1.40 or less or from 1.70 to 2.80, particularly preferably 1.40 or less or from 2.00 to 2.80. In the light-diffusing layer further containing the ultrafine particle component, a region where a refractive index continuously changes is formed near the surface of each of the light-diffusible particles. As a result, a light-diffusing film reduced in backscattering can be obtained. Details of the light-diffusing layer of this embodiment are described in, for example, JP 2012-88692 A, the entire description of which is incorporated herein by reference.

Any appropriate film may be adopted as the substrate as long as the effect of the present invention is obtained. Specific examples thereof include a triacetylcellulose (TAC) film, a polyethylene terephthalate (PET) film, a polypropylene (PP) film, a nylon film, an acrylic film, and a lactone-modified acrylic film. The substrate may be subjected to surface modification, such as easy-adhesion treatment, or may contain an additive, such as a lubricant, an antistatic agent, or a UV absorber, as required.

The thickness of the substrate is preferably from 10 μm to 100 μm.

C. Circularly Polarizing Plate

C-1. Overall Configuration of Circularly Polarizing Plate (First Embodiment)

FIG. 3 is a schematic sectional view of a circularly polarizing plate according to one embodiment of the present invention. The circularly polarizing plate 20 of this embodiment includes a polarizer 21 and a first retardation layer 22 in the stated order from the viewer side. The first retardation layer 22 may function as a λ/4 plate. In one embodiment, the circularly polarizing plate further includes a protective film (not shown) on the surface of the polarizer opposite to the first retardation layer. In addition, the circularly polarizing plate may include another protective film (also referred to as “inner protective film”: not shown) between the polarizer and the first retardation layer.

C-1-1. Polarizer and Protective Film

Any appropriate polarizer may be used as the polarizer. Examples thereof include polyene-based alignment films, such as: a product obtained by causing a hydrophilic polymer film, such as a polyvinyl alcohol-based film, a partially formalized polyvinyl alcohol-based film, or an ethylene-vinyl acetate copolymer-based partially saponified film, to adsorb a dichroic substance, such as iodine or a dichroic dye, and uniaxially stretching the resultant; a dehydration-treated product of polyvinyl alcohol; and a dehydrochlorination-treated product of polyvinyl chloride. Of those, a polarizer obtained by causing the polyvinyl alcohol-based film to adsorb the dichroic substance, such as iodine, and uniaxially stretching the resultant is particularly preferred because of its high polarization dichroic ratio. The thickness of the polarizer is preferably from 0.5 μm to 80 μm.

The polarizer obtained by causing the polyvinyl alcohol-based film to adsorb iodine and uniaxially stretching the resultant is typically produced by: immersing polyvinyl alcohol in an aqueous solution of iodine to dye the polyvinyl alcohol; and stretching the dyed polyvinyl alcohol so that the polyvinyl alcohol may have a length 3 to 7 times as long as its original length. The stretching may be performed after the dyeing, the stretching may be performed while the dyeing is performed, or the dyeing may be performed after the stretching. The polarizer is produced through treatment, such as swelling, cross-linking, adjustment, water washing, or drying, in addition to the stretching and the dyeing. For example, when the polyvinyl alcohol-based film is washed with water by being immersed in the water before the dyeing, contamination and an antiblocking agent on the surface of the polyvinyl alcohol-based film can be washed off. Moreover, the polyvinyl alcohol-based film can be swollen to prevent its dyeing unevenness or the like. The polyvinyl alcohol-based film may be a single-layer film (typical film-formed film), or may be a polyvinyl alcohol-based resin layer applied and formed onto a resin substrate. A technology for producing a polarizer from the single-layer polyvinyl alcohol-based film is well-known in the art. A technology for producing a polarizer from the polyvinyl alcohol-based resin layer applied and formed onto the resin substrate is described in, for example, JP 2009-098653 A.

The polarizer preferably shows absorption dichroism at any wavelength in the wavelength range of from 380 nm to 780 nm. The single layer transmittance of the polarizer is preferably from 40% to 45.5%, more preferably from 42% to 45.0%.

The polarization degree of the polarizer is 99.9% or more, preferably 99.95% or more. When the polarization degree falls within such ranges, a circularly polarizing plate, which exhibits a desired circular polarization function, and is excellent in antireflection characteristic can be obtained.

Any appropriate film may be used as the protective film. As a material serving as a main component of such film, there are specifically given, for example, cellulose-based resins, such as triacetylcellulose (TAC), and transparent resins, such as (meth)acrylic, polyester-based, polyvinyl alcohol-based, polycarbonate-based, polyamide-based, polyimide-based, polyether sulfone-based, polysulfone-based, polystyrene-based, polynorbornene-based, polyolefin-based, and acetate-based resins. There are also given, for example, thermosetting resins or UV-curable resins, such as acrylic, urethane-based, acrylic urethane-based, epoxy-based, and silicone-based resins. There are also given, for example, glassy polymers, such as a siloxane-based polymer. In addition, a polymer film described in JP 2001-343529 A (WO 01/37007 A1) may be used. For example, a resin composition containing a thermoplastic resin having a substituted or unsubstituted imide group on a side chain thereof, and a thermoplastic resin having a substituted or unsubstituted phenyl group and a nitrile group on side chains thereof may be used as a material for the film, and the composition is, for example, a resin composition containing an alternating copolymer formed of isobutene and N-methylmaleimide, and an acrylonitrile-styrene copolymer. The polymer film may be, for example, an extrudate of the resin composition. Any appropriate pressure-sensitive adhesive layer or adhesive layer is used in the lamination of the polarizer and the protective film. The pressure-sensitive adhesive layer is typically formed of an acrylic pressure-sensitive adhesive. The adhesive layer is typically formed of a polyvinyl alcohol-based adhesive.

C-1-2. First Retardation Layer

As described above, the first retardation layer may function as a λ/4 plate. The in-plane retardation Re(550) of such first retardation layer is preferably from 120 nm to 160 nm, more preferably from 135 nm to 155 nm. The first retardation layer typically has a refractive index ellipsoid of nx>ny≥nz. For example, the relationship “ny=nz” as used herein encompasses not only a case in which the ny and the nz are exactly equal to each other, but also a case in which the ny and the nz are substantially equal to each other.

The Rth(550) of the first retardation layer is preferably from 120 nm to 300 nm, more preferably from 135 nm to 260 nm.

The Nz coefficient of the first retardation layer is, for example, from 0.9 to 2, preferably from 1 to 1.8, more preferably from 1 to 1.7.

The polarizer and the first retardation layer are laminated so that the absorption axis of the polarizer and the slow axis of the first retardation layer may form a predetermined angle. An angle formed by the absorption axis of the polarizer and the slow axis of the first retardation layer is preferably from 35° to 55°, more preferably from 38° to 52°, still more preferably from 40° to 50°, still further more preferably from 42° to 48°, particularly preferably from 44° to 46°. When the angle falls within such ranges, a desired circular polarization function can be achieved. When reference is made to an angle in this description, the angle encompasses angles in both clockwise and counterclockwise directions unless otherwise stated.

The thickness of the first retardation layer may be set so that the layer may most appropriately function as a λ/4 plate. In other words, the thickness may be set so that a desired in-plane retardation may be obtained. Specifically, the thickness of the first retardation layer is preferably from 10 μm to 80 μm, more preferably from 10 μm to 60 μm, most preferably from 30 μm to 50 μm.

The first retardation layer may show such a reverse wavelength dispersion characteristic that its retardation value increases in accordance with an increase in wavelength of measurement light, may show such a positive wavelength dispersion characteristic that the retardation value reduces in accordance with an increase in wavelength of the measurement light, or may show such a flat wavelength dispersion characteristic that the retardation value remains substantially unchanged irrespective of the wavelength of the measurement light.

In one embodiment, the first retardation layer shows a flat wavelength dispersion characteristic. The adoption of the retardation layer showing a flat wavelength dispersion characteristic can achieve an excellent antireflection characteristic and an excellent reflection hue in an oblique direction. In addition, the image display apparatus of the present invention can achieve an excellent reflection hue even through the use of the retardation layer showing a flat wavelength dispersion characteristic. In this embodiment, the ratio Re(450)/Re(550) of the first retardation layer is preferably from 0.8 to 1.05, more preferably from 0.85 to 1.01. In addition, the ratio Re(650)/Re(550) thereof is preferably from 0.9 to 1.02.

The λ/4 plate is preferably a stretched film of a polymer film. Specifically, the λ/4 plate is obtained by appropriately selecting the kind of the polymer and stretching treatment (e.g., a stretching method, a stretching temperature, a stretching ratio, or a stretching direction).

Any appropriate resin is used as a resin for forming the polymer film. Specific examples thereof include resins for forming positive birefringent films, for example, a cycloolefin-based resin, such as polynorbornene, a polycarbonate-based resin, a cellulose-based resin, a polyvinyl alcohol-based resin, and a polysulfone-based resin. Of those, a norbornene-based resin and a polycarbonate-based resin are preferred. Details of the resin for forming the polymer film are described in, for example, JP 2014-010291 A. The description is incorporated herein by reference.

The polynorbornene refers to a (co)polymer obtained by using a norbornene-based monomer having a norbornene ring as part or the entirety of starting materials (monomers). Examples of the norbornene-based monomer include: norbornene, alkyl and/or alkylidene substituted products thereof, such as 5-methyl-2-norbornene, 5-dimethyl-2-norbornene, 5-ethyl-2-norbornene, 5-butyl-2-norbornene, and 5-ethylidene-2-norbornene, and polar group (e.g., halogen) substituted products thereof; dicyclopentadiene and 2,3-dihydrodicyclopentadiene; dimethanooctahydronaphthalene, alkyl and/or alkylidene substituted products thereof, and polar group (e.g., halogen) substituted products thereof, such as 6-methyl-1,4:5,8-dimethano-1,4,4a,5,6,7,8,8a-octahydronaphthalene, 6-ethyl-1,4:5,8-dimethano-1,4,4a,5,6,7,8,8a-octahydronaphthalene, 6-ethylidene-1,4:5,8-dimethano-1,4,4a,5,6,7,8,8a-octahydronaphthalene, 6-chloro-1,4:5,8-dimethano-1,4,4a,5,6,7,8,8a-octahydronaphthalene, 6-cyano-1,4:5,8-dimethano-1,4,4a,5,6,7,8,8a-octahydronaphthalene, 6-pyridyl-1,4:5,8-dimethano-1,4,4a,5,6,7,8,8a-octahydronaphthalene, and 6-methoxycarbonyl-1,4:5,8-dimethano-1,4,4a,5,6,7,8,8a-octahydronaphthalene; and trimers or tetramers of cyclopentadiene, such as 4,9:5,8-dimethano-3a,4,4a,5,8,8a,9,9a-octahydro-1H-benzoindene and 4,11:5,10:6,9-trimethano-3a,4,4a,5,5a,6,9,9a,10,10a,11,11a-dodecahydro-1H-cyclopentaanthracene.

Various products are commercially available as the polynorbornene. Specific examples thereof include product names “ZEONEX” and “ZEONOR” manufactured by Zeon Corporation, product name “Arton” manufactured by JSR Corporation, product name “Topas” manufactured by TICONA, and product name “APEL” manufactured by Mitsui Chemicals, Inc.

An aromatic polycarbonate is preferably used as the polycarbonate-based resin. The aromatic polycarbonate may be typically obtained by a reaction between a carbonate precursor and an aromatic dihydric phenol compound. Specific examples of the carbonate precursor include phosgene, bischloroformates of dihydric phenols, diphenyl carbonate, di-p-tolyl carbonate, phenyl-p-tolyl carbonate, di-p-chlorophenyl carbonate, and dinaphthyl carbonate. Of those, phosgene and diphenyl carbonate are preferred. Specific examples of the aromatic dihydric phenol compound include 2,2-bis(4-hydroxyphenyl)propane, 2,2-bis(4-hydroxy-3,5-dimethylphenyl)propane, bis(4-hydroxyphenyl)methane, 1,1-bis(4-hydroxyphenyl)ethane, 2,2-bis(4-hydroxyphenyl)butane, 2,2-bis(4-hydroxy-3,5-dimethylphenyl)butane, 2,2-bis(4-hydroxy-3,5-dipropylphenyl)propane, 1,1-bis(4-hydroxyphenyl)cyclohexane, and 1,1-bis(4-hydroxyphenyl)-3,3,5-trimethylcyclohexane. Those compounds may be used alone or in combination thereof. Of those, 2,2-bis(4-hydroxyphenyl)propane, 1,1-bis(4-hydroxyphenyl)cyclohexane, and 1,1-bis(4-hydroxyphenyl)-3,3,5-trimethylcyclohexane are preferably used. In particular, 2,2-bis(4-hydroxyphenyl)propane and 1,1-bis(4-hydroxyphenyl)-3,3,5-trimethylcyclohexane are preferably used in combination.

Examples of the stretching method include lateral uniaxial stretching, fixed-end biaxial stretching, and sequential biaxial stretching. The fixed-end biaxial stretching is specifically, for example, a method including stretching the polymer film in its short direction (lateral direction) while causing the film to travel in its lengthwise direction. The method may be apparently lateral uniaxial stretching. Oblique stretching may also be adopted. The adoption of the oblique stretching can provide an elongate stretched film having an alignment axis (slow axis) at a predetermined angle with respect to its widthwise direction.

The thickness of the stretched film is typically from 5 μm to 80 μm, preferably from 15 μm to 60 μm, more preferably from 25 μm to 45 μm.

C-2. Overall Configuration of Circularly Polarizing Plate (Second Embodiment)

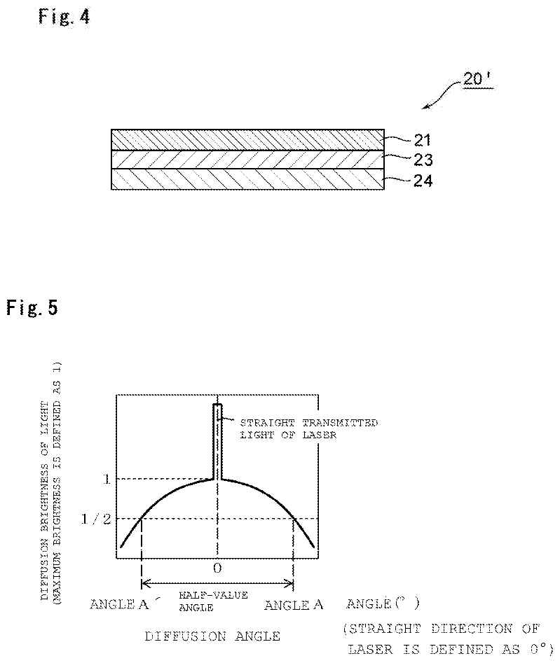

FIG. 4 is a schematic sectional view of a circularly polarizing plate according to another embodiment of the present invention. In this embodiment (second embodiment), the circularly polarizing plate 20′ includes the polarizer 21, a second retardation layer 23, and a third retardation layer 24 in the stated order from the viewer side. The second retardation layer shows a refractive index characteristic of nx>ny≥nz. In addition, the third retardation layer shows a refractive index characteristic of nz>nx≥ny. The circularly polarizing plate may practically include a protective film (not shown) configured to protect the polarizer on at least one side of the polarizer.

Also in this embodiment, the polarizer and the protective film described in the section C-1-1 may be used as the polarizer and the protective film.

C-2-1. Second Retardation Layer

As described above, the refractive index characteristic of the second retardation layer shows a relationship of nx>ny≥nz. The in-plane retardation Re(550) of the second retardation layer is preferably from 80 nm to 200 nm, more preferably from 100 nm to 180 nm, still more preferably from 110 nm to 170 nm.

The Rth(550) of the second retardation layer is preferably from 120 nm to 300 nm, more preferably from 135 nm to 260 nm.

The Nz coefficient of the second retardation layer is, for example, from 0.9 to 2, preferably from 1 to 1.8, more preferably from 1 to 1.7.

The polarizer and the second retardation layer are laminated so that the absorption axis of the polarizer and the slow axis of the second retardation layer may form a predetermined angle. An angle formed by the absorption axis of the polarizer and the slow axis of the second retardation layer is preferably from 35° to 55°, more preferably from 38° to 52°, still more preferably from 40° to 50°, still further more preferably from 42° to 48°, particularly preferably from 44° to 46°. When the angle falls within such ranges, a desired circular polarization function can be achieved.

The second retardation layer may show such a reverse wavelength dispersion characteristic that its retardation value increases in accordance with an increase in wavelength of measurement light, may show such a positive wavelength dispersion characteristic that the retardation value reduces in accordance with an increase in wavelength of the measurement light, or may show such a flat wavelength dispersion characteristic that the retardation value remains substantially unchanged irrespective of the wavelength of the measurement light.

In one embodiment, the second retardation layer shows a flat wavelength dispersion characteristic. The adoption of the retardation layer showing a flat wavelength dispersion characteristic can achieve an excellent antireflection characteristic and an excellent reflection hue in an oblique direction. In addition, the image display apparatus of the present invention can achieve an excellent reflection hue even through the use of the retardation layer showing a flat wavelength dispersion characteristic. In this embodiment, the ratio Re(450)/Re(550) of the second retardation layer is preferably from 0.8 to 1.05, more preferably from 0.85 to 1.03. In addition, the ratio Re(650)/Re(550) thereof is preferably from 0.98 to 1.02.

The second retardation layer is preferably a stretched film of a polymer film. The film described in the section C-1-2 may be used as the stretched film of the polymer film.

C-2-2. Third Retardation Layer

As described above, the refractive index characteristic of the third retardation layer shows a relationship of nz>nx≥ny. When the image display apparatus includes the third retardation layer having such refractive index characteristic, an image display apparatus, which is excellent in viewing angle characteristic, and is prevented from white blurring can be obtained. In addition, the angle dependency of the reflected light-absorbing effect of the apparatus reduces.

The thickness direction retardation Rth(550) of the third retardation layer is preferably from −260 nm to −10 nm, more preferably from −230 nm to −15 nm, still more preferably from −215 nm to −20 nm. When the thickness direction retardation falls within such ranges, the above-mentioned angle dependency-reducing effect becomes significant.

In one embodiment, the refractive indices of the third retardation layer show a relationship of nx=ny. Herein, the relationship “nx=ny” encompasses not only a case in which the nx and the ny are exactly equal to each other, but also a case in which the nx and the ny are substantially equal to each other. Specifically, the relationship means that the Re(550) of the layer is less than 10 nm. In another embodiment, the refractive indices of the third retardation layer show a relationship of nx>ny. In this case, the in-plane retardation Re(550) of the third retardation layer is preferably from 10 nm to 150 nm, more preferably from 10 nm to 80 nm.

The third retardation layer may be formed of any appropriate material. The layer is preferably a liquid crystal layer fixed in homeotropic alignment. A liquid crystal material (liquid crystal compound) that can be homeotropically aligned may be a liquid crystal monomer or a liquid crystal polymer. Specific examples of the liquid crystal compound and a method of forming the liquid crystal layer include a liquid crystal compound and a formation method described in paragraphs [0020] to [0042] of JP 2002-333642 A. In this case, the thickness of the layer is preferably from 0.1 μm to 5 μm, more preferably from 0.2 μm to 3 μm.

As another preferred specific example, the third retardation layer may be a retardation film formed of a fumaric acid diester-based resin described in JP2012-32784A. In this case, the thickness of the layer is preferably from 5 μm to 50 μm, more preferably from 10 μm to 35 μm.

C-2-3. Laminated Retardation Film

The second retardation layer and the third retardation layer forma laminated retardation film. The laminated retardation film is preferably free of any optically anisotropic layer except the second retardation layer and the third retardation layer. The optically anisotropic layer refers to a layer having an in-plane retardation Re(550) of more than 10 nm, and/or having a thickness direction retardation Rth(550) of less than −10 nm or more than 10 nm.

The in-plane retardation Re(550) of the laminated retardation film including the second retardation layer and the third retardation layer is preferably from 120 nm to 160 nm, more preferably from 130 nm to 150 nm, still more preferably from 135 nm to 145 nm. When the in-plane retardation falls within such ranges, an image display apparatus, which is excellent in viewing angle characteristic, and is prevented from white blurring, can be obtained.

The thickness direction retardation Rth(550) of the laminated retardation film including the second retardation layer and the third retardation layer is preferably from 40 nm to 100 nm, more preferably from 50 nm to 100 nm, still more preferably from 60 nm to 100 nm. When the thickness direction retardation falls within such ranges, an image display apparatus, which is excellent in viewing angle characteristic, and is prevented from white blurring, can be obtained.

The circularly polarizing plate is preferably arranged so that an angle formed by the slow axis of the circularly polarizing plate (substantially the slow axis of the laminated retardation film including the second retardation layer and the third retardation layer) and the absorption axis of the polarizer may be substantially 450 (e.g., from 40° to 50°).

D. Backlight

The half-value angle of the backlight is preferably 30° or less, more preferably 20° or less. When the half-value angle falls within such ranges, an image display apparatus excellent in viewing angle characteristic can be obtained. The lower limit of the half-value angle of the backlight is, for example, 5°. A method of measuring the half-value angle of the backlight is described later.

The backlight may be of a direct system, or may be of an edge light system.

A light source to be included in the backlight is, for example, a cold-cathode tube light source (CCFL) or a LED light source. In one embodiment, the backlight includes the LED light source. The use of the LED light source can provide an image display apparatus excellent in viewing angle characteristic.

The backlight may further include any other member, such as a light guide plate, a diffusion plate, or a prism sheet, in addition to the light source as required.

E. Liquid Crystal Panel

As illustrated in FIG. 1, the liquid crystal panel 40 typically includes a liquid crystal cell 42, a viewer-side polarizing plate 41 arranged on the viewer side of the liquid crystal cell, and a back surface-side polarizing plate 43 arranged on the back surface side of the liquid crystal cell. The viewer-side polarizing plate 41 and the back surface-side polarizing plate 43 may be arranged so that their respective absorption axes may be substantially perpendicular or parallel to each other.

The liquid crystal cell 42 includes a pair of substrates 1, 1′, and a liquid crystal layer 2 serving as a display medium, the layer being sandwiched between the substrates. In a general configuration, a color filter and a black matrix are arranged on one substrate, and a switching element configured to control the electro-optical characteristics of the liquid crystal, a scan line configured to apply a gate signal to the switching element and a signal line configured to apply a source signal thereto, and a pixel electrode and a counter electrode are arranged on the other substrate. An interval (cell gap) between the substrates may be controlled with, for example, a spacer. For example, an alignment film formed of polyimide may be arranged on the side of each of the substrates in contact with the liquid crystal layer.

In one embodiment, the liquid crystal layer contains liquid crystal molecules aligned in homeotropic alignment under a state in which no electric field is present. Such liquid crystal layer (as a result, the liquid crystal cell) typically shows a three-dimensional refractive index of nz>nx=ny. A drive mode using the liquid crystal molecules aligned in homeotropic alignment under a state in which no electric field is present is, for example, a vertical alignment (VA) mode. The VA mode encompasses a multi-domain VA (MVA) mode. It is difficult to improve the viewing angle characteristic of a liquid crystal display apparatus of a VA mode. However, when the circularly polarizing plate and the light-diffusing element are used in combination like the present invention, a liquid crystal display apparatus excellent in viewing angle characteristic can be obtained.

In another embodiment, the liquid crystal layer contains liquid crystal molecules aligned in homogeneous alignment under a state in which no electric field is present. Such liquid crystal layer (as a result, the liquid crystal cell) typically shows a three-dimensional refractive index of nx>ny=nz. The relationship “ny=nz” as used herein encompasses not only a case in which the ny and the nz are completely equal to each other, but also a case in which the ny and the nz are substantially equal to each other. Typical examples of a drive mode using the liquid crystal layer that shows such three-dimensional refractive index include an in-plane switching (IPS) mode and a fringe field switching (FFS) mode. The IPS mode encompasses a super in-plane switching (S-IPS) mode and an advanced super in-plane switching (AS-IPS) mode each of which adopts, for example, a V-shaped electrode or a zigzag electrode. In addition, the FFS mode encompasses an advanced fringe field switching (A-FFS) mode and an ultra-fringe field switching (U-FFS) mode each of which adopts, for example, a V-shaped electrode or a zigzag electrode.

Any appropriate polarizing plate may be used as each of the viewer-side polarizing plate and the back surface-side polarizing plate. For example, a polarizing plate including the polarizer and the protective film described in the section C-1-1 may be used as the polarizing plate.

### EXAMPLES

Now, the present invention is specifically described by way of Examples, but the present invention is not limited by these Examples. Evaluation methods in Examples are as described below.

(1) Retardation Value

A sample measuring 50 mm by 50 mm was cut out of each retardation layer and adopted as a measurement sample, and its retardation value was measured with AxoScan manufactured by Axometrics, Inc. A measurement wavelength was set to 550 nm, and a measurement temperature was set to 23° C.

(2) Half-Value Angle of Light-Diffusing Element

The front surface of a light-diffusing element was irradiated with laser light, and the diffusion brightness of diffused light with respect to a diffusion angle was measured with a goniophotometer every 1°. As illustrated in FIG. 5, the diffusion angles at which the brightness became one half of the maximum value of the diffusion brightness of light except the straight transmitted light of the laser were measured on both sides of a diffusion profile. A value obtained by summing up the angles on both the sides (angle A+angle A′ in FIG. 5) was adopted as the half-value angle of the light-diffusing element.

(3) Half-Value Angle of Backlight

The brightness of light output from the front surface of a backlight was measured with a conoscope. As illustrated in FIG. 6, the full width at half maximum of output angles each corresponding to a brightness equal to one half of the brightness maximum value (typically a brightness at an output angle of 0°) with respect to an output profile was adopted as the half-value angle of the backlight.

(4) Diffuse Reflectance

A light-diffusing element was bonded to a smooth black acrylic plate via a pressure-sensitive adhesive, and its diffuse reflectance was measured with a product available under the product name “CM-2600d” from Konica Minolta, Inc. under a D65 light source in a specular component excluded (SCE) mode. A measurement temperature was set to 23° C.

(5) Viewing Angle Characteristic

The viewing angle characteristic of an image display apparatus obtained in each of Examples and Comparative Examples was visually evaluated. Evaluation criteria are as described below.
∘: When human skin and a Macbeth chart are displayed on the screen of the apparatus, and the hue of the skin when viewed from a front direction and that when viewed from an oblique direction at an angle of 60° are compared, no difference therebetween is observed.
x: When human skin and a Macbeth chart are displayed on the screen of the apparatus, and the hue of the skin when viewed from a front direction and that when viewed from an oblique direction at an angle of 60° are compared, a difference therebetween is observed.

(6) White Blurring

The presence or absence of white blurring in the image display apparatus obtained in each of Examples and Comparative Examples was visually evaluated. Evaluation criteria areas described below.
∘: When black character information is reflected on a white background, and is viewed from a position distant from the surface of the screen of the apparatus by 50 cm, its contour does not appear to blur.
x: When black character information is reflected on a white background, and is viewed from a position distant from the surface of the screen of the apparatus by 50 cm, its contour appears to blur.

### [Production Example 1] Production of Stretched Film (1)

A norbornene-based cycloolefin film (manufactured by Zeon Corporation, product name: “ZEONOR”) was stretched in a uniaxial direction so as to have an in-plane retardation Re(550) of 141 nm, an Re(450) of 141 nm, and a thickness direction retardation Rth(550) of 228 nm. Thus, a stretched film (1) was obtained. The film (1) showed a refractive index characteristic of nx>ny=nz.

### [Production Example 2] Production of Stretched Film (2)

A norbornene-based cycloolefin film (manufactured by Zeon Corporation, product name: “ZEONOR”) was stretched in a uniaxial direction so as to have an in-plane retardation Re(550) of 141 nm, an Re(450) of 141 nm, and a thickness direction retardation Rth(550) of 141 nm. Thus, a stretched film (2) was obtained. The film (2) showed a refractive index characteristic of nx>ny=nz.

### [Production Example 3] Production of Stretched Film (3)

A norbornene-based cycloolefin film (manufactured by Zeon Corporation, product name: “ZEONOR”) was stretched in a uniaxial direction so as to have an in-plane retardation Re(550) of 141 nm, an Re(450) of 141 nm, and a thickness direction retardation Rth(550) of 158 nm. Thus, a stretched film (3) was obtained. The film (3) showed a refractive index characteristic of nx>ny=nz.

### [Production Example 4] Production of Stretched Film (4) (Production of Polycarbonate-Based Resin Film)

37.5 Parts by weight of isosorbide (ISB), 91.5 parts by weight of 9,9-[4-(2-hydroxyethoxy)phenyl]fluorene (BHEPF), 8.4 parts by weight of polyethylene glycol (PEG) having an average molecular weight of 400, 105.7 parts by weight of diphenyl carbonate (DPC), and 0.594 part by weight of cesium carbonate (0.2 wt % aqueous solution) serving as a catalyst were loaded into a reaction vessel. Under a nitrogen atmosphere, as the first step of a reaction, the heating medium temperature of the reaction vessel was set to 150° C., and the raw materials were dissolved while being stirred as required (about 15 minutes).

Next, a pressure in the reaction vessel was changed from normal pressure to 13.3 kPa, and produced phenol was extracted to the outside of the reaction vessel while the heating medium temperature of the reaction vessel was increased to 190° C. in 1 hour.

After a temperature in the reaction vessel had been held at 190° C. for 15 minutes, as the second step of the reaction, the pressure in the reaction vessel was set to 6.67 kPa, and the heating medium temperature of the reaction vessel was increased to 230° C. in 15 minutes, followed by the extraction of produced phenol to the outside of the reaction vessel. When the stirring torque of a stirring machine started to increase, the heating medium temperature was increased to 250° C. in 8 minutes, and the pressure in the reaction vessel was reduced to 0.200 kPa or less for removing produced phenol. After predetermined stirring torque had been achieved, the reaction was terminated, and the produced reaction product was extruded into water and then pelletized. Thus, a polycarbonate-based resin A containing structural units derived from the dihydroxy compounds at a ratio “BHEPF/ISB/PEG” of 42.9 mol %/52.8 mol %/4.3 mol % was obtained.

The resultant polycarbonate-based resin A was dried in a vacuum at 80° C. for 5 hours. After that, a polycarbonate-based resin film having a length of 3 m, a width of 300 mm, and a thickness of 120 μm was produced from the resin by using a film-forming apparatus including a single-screw extruder (manufactured by Isuzu Kakoki Co., Ltd., screw diameter: 25 mm, cylinder set temperature: 220° C.), a T-die (width: 300 mm, set temperature: 220° C.), a chill roll (set temperature: from 120° C. to 130° C.), and a winding machine.

(Production of Stretched Film (4))

The resultant polycarbonate-based resin film was cut into a size measuring 300 mm long by 300 mm wide, and was longitudinally stretched with LABOSTRETCHER KARO IV (manufactured by Bruckner Maschinenbau GmbH) at a temperature of 136° C. and a ratio of 2 times to provide a stretched film (4).

The obtained stretched film (4) had an Re(550) of 141 nm and an Rth(550) of 141 nm (nx: 1.5969, ny: 1.5942, nz: 1.5942), and showed a refractive index characteristic of nx>ny=nz. In addition, the obtained stretched film (4) had a ratio Re(450)/Re(550) of 0.85.

### [Production Example 5] Production of Third Retardation Layer

20 Parts by weight of a side chain-type liquid crystal polymer represented by the following chemical formula (I) (numerical values 65 and 35 in the formula each represent the mol % of a monomer unit, and the polymer is represented as a block polymer body for convenience: weight-average molecular weight: 5,000), 80 parts by weight of a polymerizable liquid crystal showing a nematic liquid crystal phase (manufactured by BASF: product name: Paliocolor LC242), and 5 parts by weight of a photopolymerization initiator (manufactured by Ciba Specialty Chemicals: product name: IRGACURE 907) were dissolved in 200 parts by weight of cyclopentanone to prepare a liquid crystal application liquid. Then, the application liquid was applied to a substrate film (norbornene-based resin film: manufactured by Zeon Corporation, product name: “ZEONEX”) with a bar coater, and was then heated and dried at 80° C. for 4 minutes to align the liquid crystal. UV light was applied to the liquid crystal layer to cure the liquid crystal layer. Thus, a liquid crystal fixed layer serving as a third retardation layer was formed on the substrate. The layer had an in-plane retardation Re (550) of 0 nm and a thickness direction retardation Rth(550) of −41 nm (nx: 1.5326, ny: 1.5326, nz: 1.6550), and showed a refractive index characteristic of nz>nx=ny.

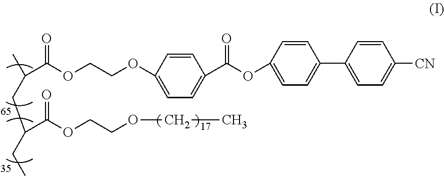

### [Production Example 6] Production of Light-Diffusing Element A

6.8 Parts by weight of a 50% MEK solution of pentaerythritol triacrylate (manufactured by Osaka Organic Chemical Industry Ltd., product name: “VISCOAT #300”, refractive index: 1.52) serving as a precursor of a resin component, 0.068 part by weight of a photopolymerization initiator (manufactured by Ciba Specialty Chemicals, product name: “IRGACURE 907”), 0.625 part by weight of a leveling agent (manufactured by DIC Corporation, product name: “GRANDIC PC-4100”), and 2.5 parts by weight of polymethyl methacrylate (PMMA) fine particles (manufactured by Soken Chemical & Engineering Co., Ltd., MX180TA) serving as light-diffusible fine particles were added to 18.2 parts by weight of a resin for hard coating (manufactured by JSR Corporation, product name: “OPSTAR KZ6661” (containing MEK/MIBK)) containing 62% of zirconia nanoparticles (average particle diameter: 60 nm, refractive index: 2.19). The mixture was treated with an ultrasonic wave for 5 minutes to prepare an application liquid in which the respective components were uniformly dispersed. The application liquid was applied onto a TAC film (manufactured by FUJIFILM Corporation, product name: “FUJITAC”) with a bar coater, and was dried at 100° C. for 1 minute. After that, the dried liquid was irradiated with UV light having an integrated light quantity of 300 mJ to provide a light-diffusing element A having a thickness of 20 μm (half-value angle: 60°, diffuse reflectance: 0.5%).

### [Production Example 7] Production of Light-Diffusing Element B

A light-diffusing element B (half-value angle: 40°, diffuse reflectance: 0.3%) was obtained in the same manner as in Production Example 6 except that: polymethyl methacrylate (PMMA) fine particles (manufactured by Negami Chemical Industrial Co., Ltd., product name: “ART PEARL J4P”, average particle diameter: 2.1 μm, refractive index: 1.49) were used as the light-diffusible fine particles; the application liquid was applied after having been left at rest for 2 hours after its preparation; the drying temperature of the liquid after its application was set to 60° C.; and the thickness of the element was set to 9 μm.

### [Production Example 8] Production of Light-Diffusing Element C

A light-diffusing element C (half-value angle: 80°, diffuse reflectance: 0.8%) was obtained in the same manner as in Production Example 6 except that the thickness of the element was set to 32 μm.

### [Production Example 9] Production of Light-Diffusing Element D

6 Parts by weight of silicone resin fine particles (manufactured by Momentive Performance Materials Inc., product name: “TOSPEARL 120”, average particle diameter: 2.0 μm, refractive index: 1.43) were added to a solution obtained by dissolving 20 parts by weight of an acrylonitrile-styrene copolymer (AS) resin (manufactured by Asahi Kasei Chemicals Corporation, product name: “STYLAC AS”, refractive index: 1.57) in 100 parts by weight of cyclopentanone (CPN). Thus, an application liquid was prepared. The application liquid had a solid content concentration of 19.4%. Immediately after its preparation, the application liquid was applied onto a TAC film (manufactured by FUJIFILM Corporation, product name: “FUJITAC”) with an applicator, and was dried at 150° C. for 1 minute to provide a light-diffusing element D having a thickness of 32 μm (half-value angle: 60°, diffuse reflectance: 1.5%).

### Example 1

The stretched film (1) obtained in Production Example 1 was used as a first retardation layer, and the light-diffusing element A obtained in Production Example 6 was used as a light-diffusing element. The light-diffusing element A, a linear polarizer (manufactured by Nitto Denko Corporation, product name: “SEG1424DU”), and the stretched film (1) were bonded to each other via an acrylic pressure-sensitive adhesive to provide a circularly polarizing plate A with a light-diffusing element (light-diffusing element/linear polarizer/first retardation layer). An angle formed by the absorption axis of the linear polarizer and the slow axis of the first retardation layer was set to 45°.

The circularly polarizing plate A was arranged on the viewer side of a liquid crystal display apparatus so that the light-diffusing element A was on the viewer side. The liquid crystal display apparatus includes a product available under the product name “C271P4QPJEW/11” from Philips, a liquid crystal cell of a multi-domain-type VA mode and a backlight “a” having a half-value angle of 80°, and two light control films (manufactured by 3M Company, product name: “Vikuiti”) laminated so as to be perpendicular to the surface of the backlight “a”, and a backlight A including the backlight and the light control films outputs light at a half-value angle of 30°.

The resultant liquid crystal display apparatus with the circularly polarizing plate A was subjected to the evaluations (5) and (6). The results are shown in Table 1.

### Example 2

A circularly polarizing plate B with a light-diffusing element (light-diffusing element/linear polarizer/first retardation layer) was produced, and a liquid crystal display apparatus including the circularly polarizing plate B was obtained in the same manner as in Example 1 except that the stretched film (2) obtained in Production Example 2 was used as the first retardation layer.

The resultant liquid crystal display apparatus with the circularly polarizing plate B was subjected to the evaluations (5) and (6). The results are shown in Table 1.

### Example 3

A circularly polarizing plate C with alight-diffusing element (light-diffusing element/linear polarizer/first retardation layer) was produced, and a liquid crystal display apparatus including the circularly polarizing plate C was obtained in the same manner as in Example 1 except that the light-diffusing element B obtained in Production Example 7 was used as the light-diffusing element.

The resultant liquid crystal display apparatus with the circularly polarizing plate C was subjected to the evaluations (5) and (6). The results are shown in Table 1.

### Example 4

A circularly polarizing plate D with a light-diffusing element (light-diffusing element/linear polarizer/first retardation layer) was produced, and a liquid crystal display apparatus including the circularly polarizing plate D was obtained in the same manner as in Example 1 except that the light-diffusing element C obtained in Production Example 8 was used as the light-diffusing element.

The resultant liquid crystal display apparatus with the circularly polarizing plate D was subjected to the evaluations (5) and (6). The results are shown in Table 1.

### Example 5

The stretched film (2) obtained in Production Example 2 was used as a second retardation layer, and the light-diffusing element A obtained in Production Example 6 was used as a light-diffusing element. The light-diffusing element A, a linear polarizer (manufactured by Nitto Denko Corporation, product name: “SEG1424DU”), the stretched film (1), and the third retardation layer produced in Production Example 5 were bonded to each other via an acrylic pressure-sensitive adhesive to provide a circularly polarizing plate E with a light-diffusing element (light-diffusing element/linear polarizer/second retardation layer/third retardation layer). The third retardation layer was formed by transferring, from the substrate film having formed thereon the liquid crystal fixed layer in Production Example 5, the liquid crystal fixed layer onto the stretched film (2). The in-plane retardation Re(550) of a laminated retardation film including the second retardation layer and the third retardation layer was 141 nm, and the thickness direction retardation Rth(550) of the laminated retardation film was 100 nm. In addition, an angle formed by the absorption axis of the linear polarizer and the slow axis of the second retardation layer was set to 450.

The resultant circularly polarizing plate E was arranged on the viewer side of a liquid crystal display apparatus so that the light-diffusing element A was on the viewer side. The liquid crystal display apparatus includes a product available under the product name “C271P4QPJEW/11” from Philips, a liquid crystal cell of a multi-domain-type VA mode and a backlight “a” having a half-value angle of 80°, and two light control films (manufactured by 3M Company, product name: “Vikuiti”) laminated so as to be perpendicular to the surface of the backlight “a”, and a backlight A including the backlight and the light control films outputs light at a half-value angle of 30°.

The resultant liquid crystal display apparatus with the circularly polarizing plate E was subjected to the evaluations (5) and (6). The results are shown in Table 1.

### Example 6

A circularly polarizing plate F with a light-diffusing element (light-diffusing element/linear polarizer/first retardation layer) was produced, and a liquid crystal display apparatus including the circularly polarizing plate F was obtained in the same manner as in Example 1 except that the stretched film (4) obtained in Production Example 4 was used as the first retardation layer.

The resultant liquid crystal display apparatus with the circularly polarizing plate F was subjected to the evaluations (5) and (6). The results are shown in Table 1.

### Example 7

A circularly polarizing plate G with alight-diffusing element (light-diffusing element/linear polarizer/second retardation layer/third retardation layer) was produced, and a liquid crystal display apparatus including the circularly polarizing plate G was obtained in the same manner as in Example 5 except that the stretched film (4) obtained in Production Example 4 was used as the second retardation layer. The in-plane retardation Re(550) of a laminated retardation film including the second retardation layer and the third retardation layer was 141 nm, and the thickness direction retardation Rth(550) of the laminated retardation film was 100 nm.

The resultant liquid crystal display apparatus with the circularly polarizing plate G was subjected to the evaluations (5) and (6). The results are shown in Table 1.

### Comparative Example 1

A linear polarizer (manufactured by Nitto Denko Corporation, product name: “SEG1424DU”) and the light-diffusing element A obtained in Production Example 6 were bonded to each other via an acrylic pressure-sensitive adhesive to provide an optical laminate C1 (linear polarizer/light-diffusing element).

The optical laminate C1 was arranged on the viewer side of a liquid crystal display apparatus so that the light-diffusing element A was on the viewer side. The liquid crystal display apparatus includes a product available under the product name “C271P4QPJEW/11” from Philips, a liquid crystal cell of a multi-domain-type VA mode and a backlight “a” having a half-value angle of 80°, and two light control films (manufactured by 3M Company, product name: “Vikuiti”) laminated so as to be perpendicular to the surface of the backlight “a”, and a backlight A including the backlight and the light control films outputs light at a half-value angle of 30°.

The resultant liquid crystal display apparatus with the optical laminate C1 was subjected to the evaluations (5) and (6). The results are shown in Table 1.

### Comparative Example 2

A circularly polarizing plate C2 with alight-diffusing element (light-diffusing element/linear polarizer/first retardation layer) was produced, and a liquid crystal display apparatus including the circularly polarizing plate C2 was obtained in the same manner as in Example 1 except that: the stretched film (3) obtained in Production Example 3 was used as the first retardation layer; and the light-diffusing element D obtained in Production Example 9 was used as the light-diffusing element.

The resultant liquid crystal display apparatus with the circularly polarizing plate C2 was subjected to the evaluations (5) and (6). The results are shown in Table 1.

### Comparative Example 3

A circularly polarizing plate C3 with alight-diffusing element (light-diffusing element/linear polarizer/first retardation layer) was obtained in the same manner as in Example 1 except that the stretched film (3) obtained in Production Example 3 was used as the first retardation layer. The circularly polarizing plate C3 was arranged on the viewer side of a liquid crystal display apparatus (including a product available under the product name “C271P4QPJEW/11” from Philips, a liquid crystal cell of a VA mode, and a backlight having a half-value angle of 80°) so that the light-diffusing element A was on the viewer side.

The resultant liquid crystal display apparatus with the circularly polarizing plate C3 was subjected to the evaluations (5) and (6). The results are shown in Table 1.

### Comparative Example 4

A circularly polarizing plate C4 was produced, and a liquid crystal display apparatus including the circularly polarizing plate C4 was obtained in the same manner as in Example 2 except that the light-diffusing element A was not arranged.

The resultant liquid crystal display apparatus with the circularly polarizing plate C4 was subjected to the evaluations (5) and (6). The results are shown in Table 1.

TABLE 1

| | | | | | | | | | | | Laminated | | | | |
|---|---|---|---|---|---|---|---|---|---|---|---|---|---|---|---|
| | | | | | | | | | | | retardation | | | | |
| | | | | | | | | | | | film | | | | |
| | | | | | | | | | | | (second | | Half- | | |
| | | | | | | | | | | | retardation | | value | | |
| | | Light-diffusing element | | | | First retardation layer | | | | | layer/third | | angle | View- | |
| | | | Half- | Diffuse | | | | Re | | Second | retardation | | of | ing | |
| | | | value | reflec- | Thick- | | | (450)/ | | retar- | layer) | | back- | angle | White |
| | | | angle | tance | ness | | Re | Re | Rth | dation | Re | Rth | light | charac- | blur- |
| | Configuration | | (°) | (%) | (μm) | | (550) | (550) | (550) | layer | (550) | (550) | (°) | teristic | ring |
| Example | Light-diffusing | Light- | 60 | 0.5 | 20 | Stretched | 141 | 1.00 | 228 | — | — | — | 30 | ∘ | ∘ |
| 1 | element/ | diffusing | | | | film (1) | | | | | | | | | |
| | circularly | element (A) | | | | | | | | | | | | | |
| Example | polarizing | Light- | 60 | 0.5 | 20 | Stretched | 141 | 1.00 | 141 | — | — | — | 30 | ∘ | ∘ |
| 2 | plate (linear | diffusing | | | | film (2) | | | | | | | | | |
| | polarizer/first | element (A) | | | | | | | | | | | | | |
| Example | retardation | Light- | 40 | 0.3 | 9 | Stretched | 141 | 1.00 | 228 | — | — | — | 30 | ∘ | ∘ |
| 3 | layer)/backlight | diffusing | | | | film (1) | | | | | | | | | |
| | | element (B) | | | | | | | | | | | | | |
| Example | | Light- | 80 | 0.8 | 32 | Stretched | 141 | 1.00 | 228 | — | — | — | 30 | ∘ | ∘ |
| 4 | | diffusing | | | | film (1) | | | | | | | | | |
| | | element (C) | | | | | | | | | | | | | |
| Example | Light-diffusing | Light- | 60 | 0.5 | 20 | — | — | — | — | Stretched | 141 | 100 | 30 | ∘ | ∘ |
| 5 | element/ | diffusing | | | | | | | | film (2) | | | | | |
| | circularly | element (A) | | | | | | | | | | | | | |
| | polarizing | | | | | | | | | | | | | | |
| | plate (linear | | | | | | | | | | | | | | |
| | polarizer/ | | | | | | | | | | | | | | |
| | second | | | | | | | | | | | | | | |
| | retardation | | | | | | | | | | | | | | |
| | layer/third | | | | | | | | | | | | | | |
| | retardation | | | | | | | | | | | | | | |
| | layer)/backlight | | | | | | | | | | | | | | |
| Example | Light-diffusing | Light- | 60 | 0.5 | 20 | Stretched | 141 | 0.85 | 141 | — | — | — | 30 | ∘ | ∘ |
| 6 | element/ | diffusing | | | | film (4) | | | | | | | | | |
| | circularly | element (A) | | | | | | | | | | | | | |
| | polarizing | | | | | | | | | | | | | | |
| | plate (linear | | | | | | | | | | | | | | |
| | polarizer/first | | | | | | | | | | | | | | |
| | retardation | | | | | | | | | | | | | | |
| | layer)/backlight | | | | | | | | | | | | | | |
| Example | Light-diffusing | Light- | 60 | 0.5 | 20 | — | — | — | — | Stretched | 141 | 100 | 30 | ∘ | ∘ |
| 7 | element/ | diffusing | | | | | | | | film (4) | | | | | |
| | circularly | element (A) | | | | | | | | | | | | | |
| | polarizing | | | | | | | | | | | | | | |
| | plate (linear | | | | | | | | | | | | | | |
| | polarizer/ | | | | | | | | | | | | | | |
| | second | | | | | | | | | | | | | | |
| | retardation | | | | | | | | | | | | | | |
| | layer/third | | | | | | | | | | | | | | |
| | retardation | | | | | | | | | | | | | | |
| | layer)/backlight | | | | | | | | | | | | | | |
| Compar- | Light-diffusing | Light- | 60 | 0.5 | 20 | — | — | — | — | — | — | — | 30 | ∘ | x |
| ative | element/linear | diffusing | | | | | | | | | | | | | |
| Example | polarizer/ | element (A) | | | | | | | | | | | | | |
| 1 | backlight | | | | | | | | | | | | | | |
| Compar- | Light-diffusing | Light- | 60 | 1.5 | 32 | Stretched | 141 | 1.00 | 158 | — | — | — | 30 | ∘ | x |
| ative | element/ | diffusing | | | | film (3) | | | | | | | | | |
| Example | circularly | element (D) | | | | | | | | | | | | | |
| 2 | polarizing | | | | | | | | | | | | | | |
| Compar- | plate (linear | Light- | 60 | 0.5 | 20 | Stretched | 141 | 1.00 | 158 | — | — | — | 80 | x | ∘ |
| ative | polarizer/first | diffusing | | | | film (3) | | | | | | | | | |
| Example | retardation | element (A) | | | | | | | | | | | | | |
| 3 | layer)/backlight | | | | | | | | | | | | | | |
| Compar- | Circularly | — | — | — | — | Stretched | 141 | 1.00 | 141 | — | — | — | 30 | x | ∘ |
| ative | polarizing | | | | | film (2) | | | | | | | | | |
| Example | plate (linear | | | | | | | | | | | | | | |
| 4 | polarizer/first | | | | | | | | | | | | | | |
| | retardation | | | | | | | | | | | | | | |
| | layer)/backlight | | | | | | | | | | | | | | |

### REFERENCE SIGNS LIST

10 light-diffusing element
11 light-diffusing layer
12 substrate
20, 20′ circularly polarizing plate
21 polarizer
22 first retardation layer
23 second retardation layer
24 third retardation layer
30 backlight
40 liquid crystal panel

1. An image display apparatus, comprising in the stated order from a viewer side thereof:
a light-diffusing element;
a circularly polarizing plate; and
a backlight,
wherein the light-diffusing element has a half-value angle of from 40° to 80°,
wherein the light-diffusing element has a diffuse reflectance of less than 1.5%, and
wherein the backlight has a half-value angle of 30° or less.

2. The image display apparatus according to claim 1,
wherein the circularly polarizing plate includes a polarizer and a first retardation layer in the stated order from the viewer side,
wherein the first retardation layer shows a refractive index characteristic of nx>ny≥nz,
wherein the first retardation layer has an in-plane retardation Re(550) of from 120 nm to 160 nm, and
wherein an angle formed by an absorption axis of the polarizer and a slow axis of the first retardation layer is from 35° to 55°,
where Re(550) represents an in-plane retardation measured at 23° C. with light having a wavelength of 550 nm.

3. The image display apparatus according to claim 2, wherein the first retardation layer satisfies a relationship of 0.8≤Re(450)/Re(550)≤1.05 where Re(450) represents an in-plane retardation measured at 23° C. with light having a wavelength of 450 nm, and Re(550) represents the in-plane retardation measured at 23° C. with the light having a wavelength of 550 nm.

4. The image display apparatus according to claim 1,
wherein the circularly polarizing plate includes a polarizer, a second retardation layer, and a third retardation layer in the stated order from the viewer side,
wherein the second retardation layer shows a refractive index characteristic of nx>ny≥nz,
wherein the third retardation layer shows a refractive index characteristic of nz>nx≥ny,
wherein a laminated retardation film including the second retardation layer and the third retardation layer has an in-plane retardation Re(550) of from 120 nm to 160 nm, and a thickness direction retardation Rth(550) of from 40 nm to 100 nm, and
wherein an angle formed by an absorption axis of the polarizer and a slow axis of the second retardation layer is from 35° to 55°,
where Re(550) represents an in-plane retardation measured at 23° C. with light having a wavelength of 550 nm, and Rth(550) represents a thickness direction retardation measured at 23° C. with the light having a wavelength of 550 nm.

5. The image display apparatus according to claim 4, wherein the second retardation layer satisfies a relationship of 0.8≤Re(450)/Re(550)≤1.05 where Re(450) represents an in-plane retardation measured at 23° C. with light having a wavelength of 450 nm, and Re(550) represents the in-plane retardation measured at 23° C. with the light having a wavelength of 550 nm.

6. The image display apparatus according to claim 1, further comprising a liquid crystal cell of a VA mode between the circularly polarizing plate and the backlight.

7. The image display apparatus according to claim 1, wherein the backlight includes a LED light source.
